(19) United States
(12) Patent Application Publication
(10) Pub. No.: US 2026/0141660 A1
(43) Pub. Date: May 21, 2026

(54) INFORMATION PROCESSING APPARATUS

(71) Applicant: CANON KABUSHIKI KAISHA, Tokyo (JP)

(72) Inventors: MASAYA HOKAZONO, Kanagawa (JP); MINORU SAKAIDA, Kanagawa (JP)

(21) Appl. No.: 19/393,919

(22) Filed: Nov. 19, 2025

(30) Foreign Application Priority Data
Nov. 21, 2024 (JP) 2024-203202

(51) Int. Cl. G06T 19/20; G06F 3/01; G06T 3/40

(52) U.S. Cl. CPC G06T 19/20; G06F 3/016; G06T 3/40; G06T 2219/2004

(57) ABSTRACT

A information processing apparatus executes acquisition processing of acquiring information of a position and an orientation of an operation part that is a part of a user performing an operation, and executes determination processing of determining a position and an orientation of a virtual operation part corresponding to the operation part, in a virtual space to be presented to the user, on a basis of the position and orientation of the operation part, wherein a haptic sensation reproducing a virtual haptic sensation that the virtual operation part receives from a virtual object in the virtual space is applied to the operation part by an ultrasonic wave from a haptic device, and in the determination processing, the position and orientation of the virtual operation part are determined such that the virtual operation part moves by a movement distance larger than a movement distance of the operation part.

### BACKGROUND

### Field of the Technology

The present disclosure relates to an information processing apparatus that is used together with a haptic device (haptic sensation generation device) that presents a haptic sensation with an ultrasonic wave and controls a virtual space to be presented (displayed) to a user.

### Description of the Related Art

Japanese Patent Laid-Open No. 2019-525344 discloses aerial haptic sensation feedback (aerial haptics) using a continuous distribution of sound energy called a “sound field”. By using the aerial haptics, a user can obtain a haptic sensation related to a virtual space such as an augmented reality (AR) space or a mixed reality (MR) space without wearing a haptic glove or the like.

However, in the aerial haptics, since ultrasonic waves emitted from a haptic device forming a sound field attenuate, the haptic sensation attenuates and eventually disappears as a distance from the haptic device increases. Such a change in the haptic sensation gives a sense of discomfort to the user. For example, in a case where the user picks up a virtual object with a finger, even though the user keeps holding the same virtual object, the user moves the finger away from the haptic device, and the haptic sensation changes (attenuates or disappears).

### SUMMARY

The present disclosure provides a technology that enables haptic sensation presentation without a sense of discomfort of a user in aerial haptics.

The present disclosure in its first aspect provides an information processing apparatus including a processor, and a memory storing a program which, when executed by the processor, causes the information processing apparatus to execute acquisition processing of acquiring information of a position and an orientation of an operation part that is a part of a user performing an operation, and execute determination processing of determining a position and an orientation of a virtual operation part corresponding to the operation part, in a virtual space to be presented to the user, on a basis of the position and orientation of the operation part, wherein a haptic sensation reproducing a virtual haptic sensation that the virtual operation part receives from a virtual object in the virtual space is applied to the operation part by an ultrasonic wave from a haptic device, and in the determination processing, the position and orientation of the virtual operation part are determined such that the virtual operation part moves by a movement distance larger than a movement distance of the operation part.

The present disclosure in its second aspect provides an information processing method including acquiring information of a position and an orientation of an operation part that is a part of a user performing an operation, and determining a position and an orientation of a virtual operation part corresponding to the operation part, in a virtual space to be presented to the user, on a basis of the position and orientation of the operation part, wherein a haptic sensation reproducing a virtual haptic sensation that the virtual operation part receives from a virtual object in the virtual space is applied to the operation part by an ultrasonic wave from a haptic device, and the position and orientation of the virtual operation part are determined such that the virtual operation part moves by a movement distance larger than a movement distance of the operation part.

The present disclosure in its third aspect provides a non-transitory computer readable medium that stores a program, wherein the program causes a computer to execute an information processing method including acquiring information of a position and an orientation of an operation part that is a part of a user performing an operation; and determining a position and an orientation of a virtual operation part corresponding to the operation part, in a virtual space to be presented to the user, on a basis of the position and orientation of the operation part, wherein a haptic sensation reproducing a virtual haptic sensation that the virtual operation part receives from a virtual object in the virtual space is applied to the operation part by an ultrasonic wave from a haptic device, and the position and orientation of the virtual operation part are determined such that the virtual operation part moves by a movement distance larger than a movement distance of the operation part.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of an information processing system according to a first embodiment.

FIG. 2A is an external view of an HMD.

FIG. 2B is an external view of a haptic device.

FIGS. 3A to 3D are schematic diagrams of operations by a user.

FIG. 4 is a flowchart of an information processing system according to the first embodiment.

FIG. 5 is an explanatory diagram of processing of S406.

FIGS. 6A to 6D are explanatory diagrams of processing of S407.

FIGS. 7A to 7C are explanatory diagrams of the presence or absence of the processing of S407.

FIG. 8 is a block diagram of an information processing system according to a second embodiment.

FIG. 9 is a flowchart illustrating an information processing system according to the second embodiment.

FIGS. 10A and 10B are explanatory diagrams of a part of processing of S901 and S902.

### DESCRIPTION OF THE EMBODIMENTS

### First Embodiment

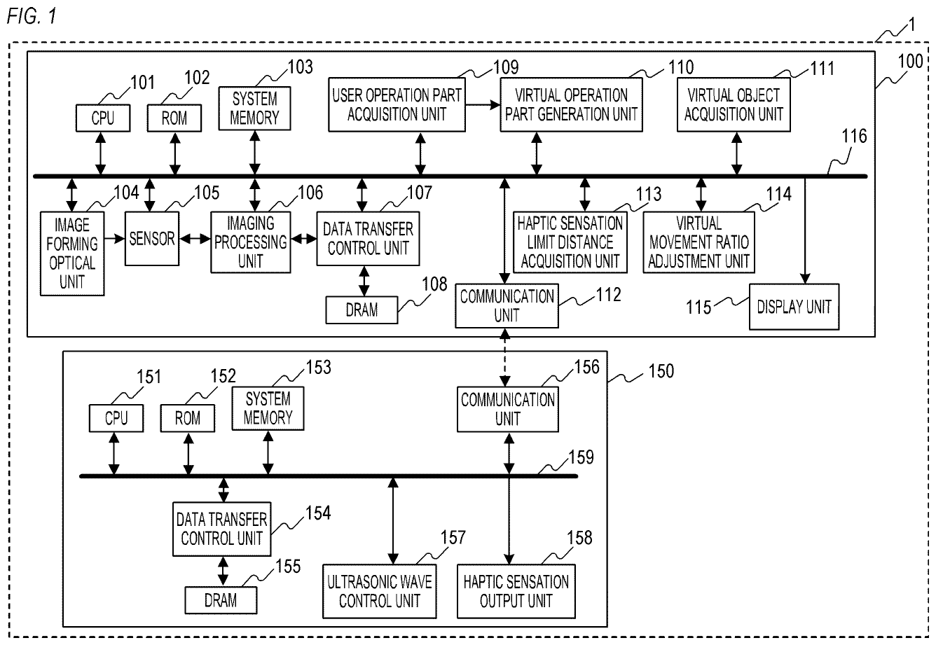

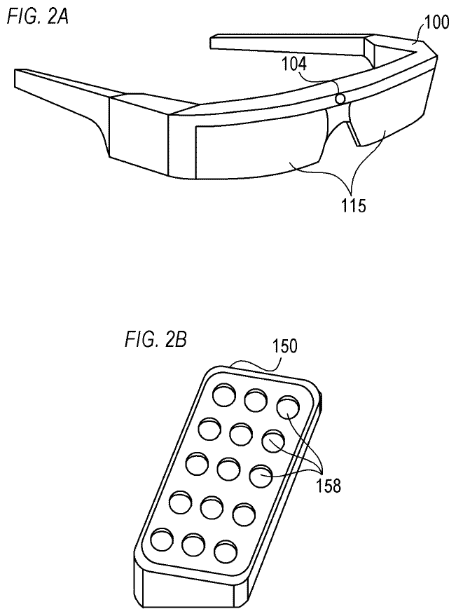

Hereinafter, a first embodiment of the present disclosure will be described. FIG. 1 is a block diagram illustrating a functional configuration of an information processing system 1 according to the first embodiment. FIG. 2A is an external view illustrating an example of an external appearance of a head mounted display (HMD) 100, and FIG. 2B is an external view illustrating an example of an external appearance of a haptic device 150. The information processing system 1 includes the HMD 100 as an example of an information processing apparatus to which the present disclosure is applied, and the haptic device 150. The HMD 100 presents a virtual space such as an augmented reality (AR) space or a mixed reality (MR) space to a user. The haptic device 150 performs haptic sensation presentation (aerial haptics) by an ultrasonic wave. Note that, the present disclosure is applicable not only to the HMD but also to various information processing apparatuses. For example, the present disclosure is also applicable to a personal computer or the like connected to the HMD. As a device for presenting the virtual space to the user, a holographic display or the like may be used instead of the HMD.

The HMD 100 will be described. Each component of the HMD 100 is connected to an internal bus 116, and data is transmitted and received in the HMD 100 via the internal bus 116.

A CPU 101 performs various types of control by loading a program stored in a ROM 102 in a system memory 103 and executing the program. The ROM 102 stores programs executable by the CPU 101 and various setting values of the HMD 100. The system memory 103 is configured with, for example, a RAM (volatile memory using a semiconductor element or the like).

An image forming optical unit 104 includes a lens, a diaphragm, and the like, and performs focus adjustment and exposure adjustment. A sensor 105 is a sensor such as a CMOS that converts an optical image of an object into an electrical signal to obtain an image, and converts an analog image signal of the object into digital image data by an A/D conversion circuit and outputs the digital image data. Note that, although FIG. 1 illustrates one sensor, the HMD 100 may include a plurality of sensors. In addition, optical information may be converted into an electrical signal by using a depth sensor such as LiDAR. An imaging processing unit 106 performs image processing such as noise removal on the digital image data output from the sensor 105.

A data transfer control unit 107 controls writing or reading of data to or from a DRAM 108. The DRAM 108 is a memory for temporarily storing data.

A user operation part acquisition unit 109 detects a user operation part that is a part (for example, hand) of the user performing an operation in a virtual space from an image (an image in a real space) processed by the imaging processing unit 106, and acquires information of a position and an orientation (for example, an orientation of the hand) of the user operation part. The information of the position and orientation of the user operation part is, for example, three-dimensional data representing the position and orientation of the user operation part. The three-dimensional data may further represent a shape of the user operation part.

A virtual operation part generation unit 110 determines a position and an orientation of a virtual operation part, which is a virtual object, which corresponds to the user operation part, in the virtual space on the basis of the information (the position and orientation of the user operation part) acquired by the user operation part acquisition unit 109, and generates the virtual operation part. The generation of the virtual operation part is, for example, generation of three-dimensional data representing the position and orientation of the virtual operation part. The three-dimensional data may further represent a shape of the virtual operation part. The virtual operation part generation unit 110 repeatedly updates the position and orientation of the virtual operation part such that the movement of the virtual operation part is interlocked with the movement of the user operation part.

A virtual object acquisition unit 111 includes a communication unit (not illustrated) and acquires virtual object information from an outside of the HMD 100. The virtual object information is information of the virtual object arranged in the virtual space, and includes, for example, three-dimensional data representing a position, a shape, and an orientation of the virtual object, and haptic information representing texture, weight, and the like of the virtual object.

A communication unit 112 performs wired or wireless communication with the outside of the HMD 100. In the first embodiment, the communication unit 112 of the HMD 100 performs communication (transmission and reception of electrical signals) with a communication unit 156 of the haptic device 150.

A haptic sensation limit distance acquisition unit 113 acquires information of a maximum distance from the haptic device 150, at which the haptic device 150 can give a certain haptic sensation to the user operation part. A distance from the haptic device 150 is, for example, a distance from an ultrasonic wave output surface of the haptic device 150. In the first embodiment, the haptic sensation limit distance acquisition unit 113 acquires information of the maximum distance by calculation, but the haptic sensation limit distance acquisition unit 113 may acquire information of a maximum distance from the outside of the HMD 100. For example, the haptic sensation limit distance acquisition unit 113 may acquire the information of the maximum distance from the haptic device 150 via the communication unit 112. In a case where the information of the maximum distance is acquired from the haptic device 150, the maximum distance may be a fixed distance determined in accordance with the ability (for example, a maximum output intensity of the ultrasonic wave) of the haptic device 150, or may be a distance that changes in accordance with a setting change of the haptic device 150. The maximum output intensity of the ultrasonic wave may be a predetermined fixed intensity or may be an intensity that changes in accordance with the setting change of the haptic device 150.

A virtual movement ratio adjustment unit 114 adjusts a degree of movement of the virtual operation part generated by the virtual operation part generation unit 110 on the basis of the maximum distance acquired by the haptic sensation limit distance acquisition unit 113.

A display unit 115 presents (displays) a video in the virtual space including the virtual operation part generated by the virtual operation part generation unit 110, the virtual object, the virtual object acquired by the virtual object acquisition unit 111, and the like to the user.

The haptic device 150 will be described. Each component of the haptic device 150 is connected to an internal bus 159, and data is transmitted and received in the haptic device 150 via the internal bus 159.

A CPU 151 performs various types of control by loading a program stored in a ROM 152 in a system memory 153 and executing the program. The ROM 152 stores programs executable by the CPU 151 and various setting values of the haptic device 150. The system memory 153 is configured with, for example, a RAM (volatile memory using a semiconductor element or the like).

A data transfer control unit 154 controls writing or reading of data to or from a DRAM 155. The DRAM 155 is a memory for temporarily storing data.

The communication unit 156 performs wired or wireless communication with the outside of the haptic device 150. In the first embodiment, the communication unit 156 of the haptic device 150 performs communication (transmission and reception of electrical signals) with the communication unit 112 of the HMD 100.

An ultrasonic control unit 157 controls a waveform of an ultrasonic wave to be output. The waveform of the ultrasonic wave is controlled, and thus, it is possible to control the haptic sensation applied to the user operation part.

A haptic sensation output unit 158 outputs ultrasonic waves. For example, the haptic sensation output unit 158 includes a plurality of ultrasonic speakers arranged in an array, and each of the plurality of ultrasonic speakers outputs an ultrasonic wave. Haptic sensation is felt at a collection point where sound energy is concentrated in the ultrasonic waves emitted from the plurality of ultrasonic speakers.

Note that, at least some of a plurality of components included in the HMD 100 in FIG. 1 may be provided in an external device (for example, the haptic device 150) of the HMD 100. Similarly, at least a part of the plurality of components included in the haptic device 150 in FIG. 1 may be provided in the external device (for example, the HMD 100) of the haptic device 150.

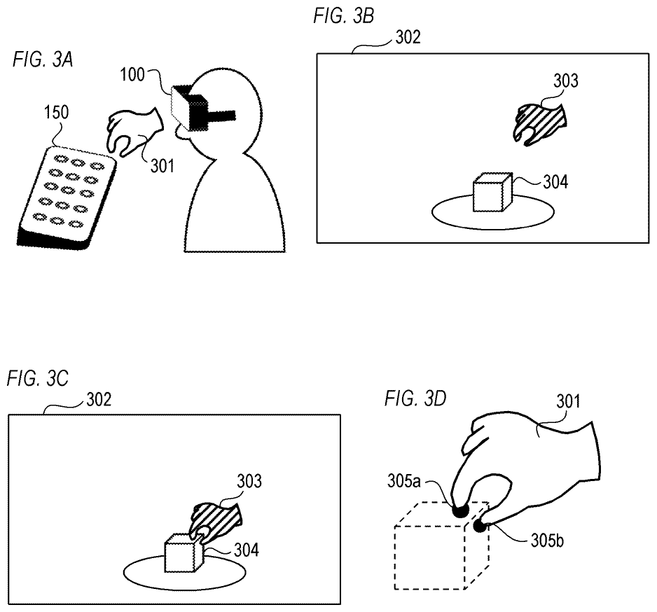

FIGS. 3A to 3D are schematic diagrams illustrating an example of an operation by the user. FIG. 3A illustrates the real space. As illustrated in FIG. 3A, the user wears the HMD 100 and performs an operation with a hand (user hand) 301. FIG. 3B illustrates a video in a virtual space 302 displayed by the display unit 115 and visually recognized by the user. In FIG. 3B, a virtual hand 303 corresponding to the user hand 301 and a virtual object 304 are displayed in the virtual space 302 (field of view). When the user moves the user hand 301, the virtual hand 303 moves in the same manner as the user hand 301. FIG. 3C illustrates a video in the virtual space 302, and illustrates a state after the user moves the hand from the state of FIG. 3B. In FIG. 3C, the virtual hand 303 (an index finger of the virtual hand 303 and a thumb of the virtual hand 303) touches the virtual object 304. In the state of FIG. 3C, a haptic sensation that reproduces a virtual haptic sensation that the virtual hand 303 receives from the virtual object 304 in the virtual space 302 is given to the user hand 301 by the ultrasonic waves from the haptic device 150. FIG. 3D illustrates the user hand 301 in the state of FIG. 3C. A haptic sensation that reproduces a virtual haptic sensation that the index finger of the virtual hand 303 receives from the virtual object 304 is given to an index finger 305a of the user hand 301, and a haptic sensation that reproduces a virtual haptic sensation that the thumb of the virtual hand 303 receives from the virtual object 304 is given to a thumb 305b of the user hand 301.

Since the ultrasonic waves emitted from the haptic device 150 attenuate, the haptic sensation attenuates and eventually disappears as the distance from the haptic device 150 increases. Such a change in the haptic sensation gives a sense of discomfort to the user. An output intensity (amplitude) of the ultrasonic wave by the haptic device 150 is increased in accordance with an increase in distance from the haptic device 150 to the user operation part, and thus, it is possible to suppress an unnecessary change in the haptic sensation (attenuation or disappearance). However, since the output intensity of the ultrasonic wave by the haptic device 150 has an upper limit (maximum output intensity), when the user operation part is excessively separated from the haptic device 150, the unnecessary change (attenuation or disappearance) in the haptic sensation occurs.

Therefore, in the first embodiment, the position and orientation of the virtual operation part are determined such that the virtual operation part moves by a movement distance larger than a movement distance of the user operation part. As a result, even in a case where the user wants to greatly move the virtual operation part, it is possible to suppress the excessive separation of the user operation part from the haptic device 150, suppress the unnecessary change in the haptic sensation, and perform haptic sensation presentation without the sense of discomfort of the user.

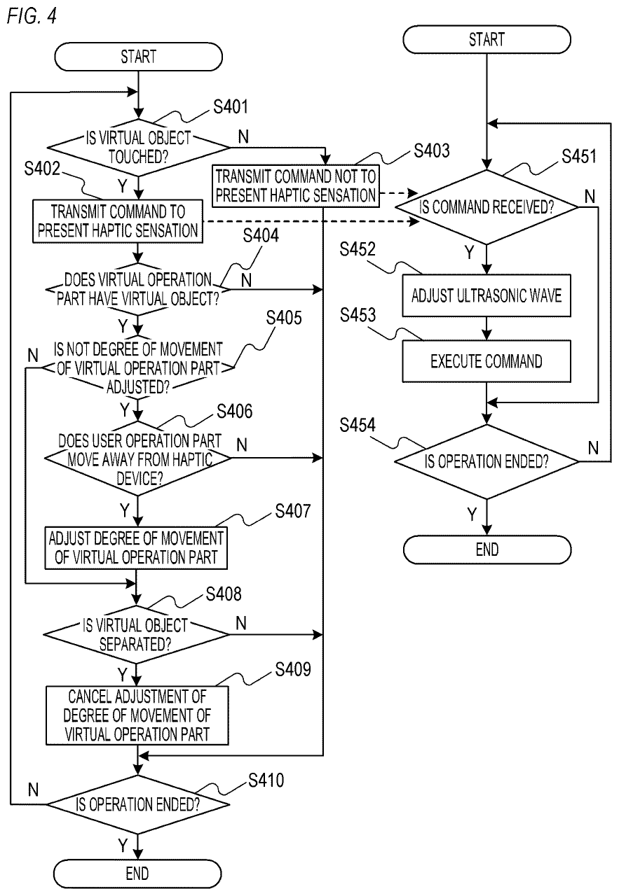

FIG. 4 is a flowchart illustrating an example of operations of the information processing system 1 according to the first embodiment. Operations (S401 to S410) of the HMD 100 are realized by the CPU 101 of the HMD 100 loading the program stored in the ROM 102 into the system memory 103 and executing the program. Operations (S451 to S454) of the haptic device 150 are realized by the CPU 151 of the haptic device 150 loading the program stored in the ROM 152 into the system memory 153 and executing the program.

The operations of the HMD 100 will be described. In S401, the CPU 101 determines whether or not the virtual operation part touches the virtual object. For example, the CPU 101 determines whether or not the virtual hand 303 touches the virtual object 304. In a case where the virtual operation part touches the virtual object, the processing proceeds to S402, and otherwise, the processing proceeds to S403.

Various known methods can be used for the determination in S401. For example, a method for comparing three-dimensional coordinates of the virtual operation part in a three-dimensional virtual space with three-dimensional coordinates of the virtual object, a method for comparing two-dimensional coordinates of the virtual operation part in a two-dimensional video in the virtual space with the two-dimensional coordinates of the virtual object, or the like can be used.

When the determination in S401 is performed, the CPU 101 causes the virtual operation part generation unit 110 to generate the virtual operation part and causes the virtual object acquisition unit 111 to acquire the virtual object information. Then, as the information necessary for the determination in S401, the CPU 101 acquires the information of the position and orientation (and shape) of the virtual operation part from the virtual operation part generation unit 110 and acquires the information of the position, orientation, and shape of the virtual object from the virtual object acquisition unit 111.

In S402, the CPU 101 controls the communication unit 112 to output a command to perform haptic sensation presentation (a command to output the ultrasonic wave) to the haptic device 150. This command includes, for example, information of a haptic sensation intensity, information of the position and orientation of the user operation part, and the like. The haptic sensation intensity is calculated on the basis of, for example, a type of the virtual object 304, a method for holding the virtual hand 303 and touching the virtual object 304, and the like.

In S403, the CPU 101 controls the communication unit 112 to output a command not to perform haptic sensation presentation (a command not to output the ultrasonic wave) to the haptic device 150.

In S404, the CPU 101 determines whether or not the virtual operation part has the virtual object. For example, the CPU 101 determines whether or not the virtual hand 303 holds the virtual object 304. In a case where the virtual operation part has the virtual object, the processing proceeds to S405, and otherwise, the processing proceeds to S410.

Various known methods can be used for the determination in S404. For example, a method of using a touching time between the virtual operation part and the virtual object, a method for performing dynamic calculation on the basis of the position and orientation (and shape) of the virtual operation part and the position, orientation, and shape of the virtual object, and the like can be used.

The CPU 101 may or may not perform the determination in S404 by using the information acquired in S401. The CPU 101 may cause the virtual operation part generation unit 110 to generate the virtual operation part and cause the virtual object acquisition unit 111 to acquire the virtual object information also when the determination in S404 is performed. Then, as the information necessary for the determination in S404, the CPU 101 may acquire the information of the position and orientation (and shape) of the virtual operation part from the virtual operation part generation unit 110 and acquire the information of the position, orientation, and shape of the virtual object from the virtual object acquisition unit 111.

In S405, the CPU 101 determines whether or not the degree of movement of the virtual operation part is adjusted (whether or not the processing of S407 is performed). In a case where the degree of movement is adjusted, the processing proceeds to S408, and otherwise, the processing proceeds to S406.

In S406, the CPU 101 determines whether or not the user operation part moves away from the haptic device 150. For example, the CPU 101 determines whether or not the user hand 301 moves away from the haptic device 150. In a case where the user operation part moves away from the haptic device 150, the processing proceeds to S407, and otherwise, the processing proceeds to S410. A direction of moving away is not particularly limited, but in the first embodiment, it is determined whether or not the user operation part moves away from the haptic device 150 in a direction perpendicular to the ultrasonic wave output surface of the haptic device 150.

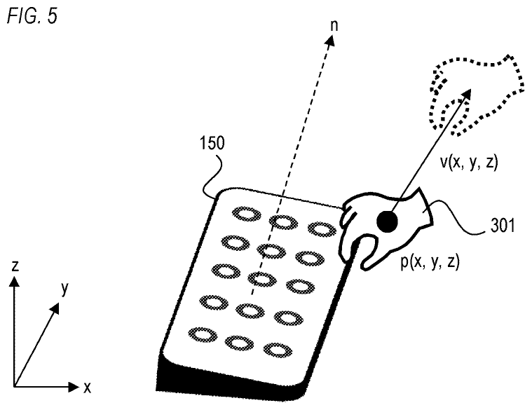

An example of the processing of S406 will be described with reference to FIG. 5. The CPU 101 causes the user operation part acquisition unit 109 to acquire three-dimensional coordinates p(x, y, z) of the user hand 301 at a predetermined cycle. The CPU 101 acquires a motion vector v(x, y, z) of the user hand 301 on the basis of a temporal change in the three-dimensional coordinates p(x, y, z). The CPU 101 stores in advance information of a normal vector n(x, y, z) of the ultrasonic wave output surface of the haptic device 150. The CPU 101 may detect the haptic device 150 from the image (the image in the real space) processed by the imaging processing unit 106 and acquire the information of the normal vector n(x, y, z). The CPU 101 calculates a value of an inner product of the normal vector n(x, y, z) and the motion vector v(x, y, z), as an evaluation value N of the movement of the user hand 301 moving away from the haptic device 150 in a direction of the normal vector n(x, y, z). The CPU 101 determines whether or not the evaluation value N is larger than a predetermined threshold. In a case where the evaluation value N is larger than the predetermined threshold, the CPU 101 determines that the user hand 301 moves away from the haptic device 150 in the direction of the normal vector n(x, y, z). In a case where the evaluation value N is equal to or less than the predetermined threshold, the CPU 101 determines that the user hand 301 does not move away from the haptic device 150 in the direction of the normal vector n(x, y, z).

In S407, the CPU 101 causes the virtual movement ratio adjustment unit 114 to adjust the degree of movement of the virtual operation part to move the virtual operation part. The degree of movement of the virtual operation part is, for example, a ratio (linking coefficient) of the movement distance of the virtual operation part to the movement distance of the user operation part.

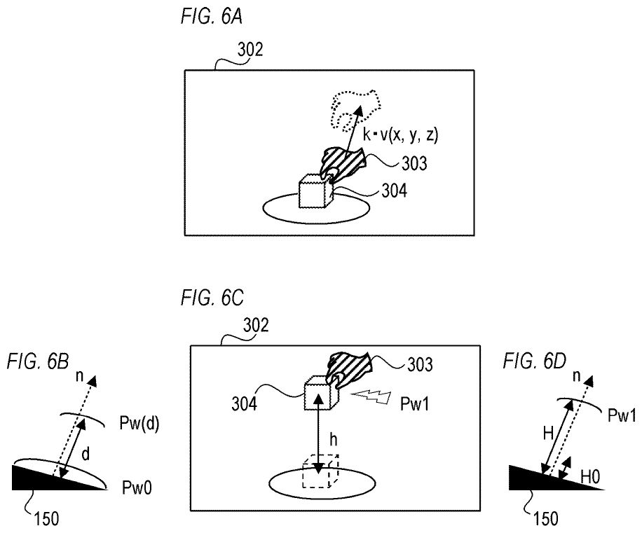

An example of the processing of S407 will be described with reference to FIGS. 6A to 6D. FIGS. 6A and 6C illustrate videos in the virtual space 302 displayed by the display unit 115 and visually recognized by the user. FIGS. 6B and 6D illustrate the haptic device 150 as viewed from a side surface of the haptic device 150.

A default value of the ratio (linking coefficient) of the movement distance of the virtual hand 303 to the movement distance of the user hand 301 is a one-dimensional coefficient k (predetermined ratio). This means that, in a case where the user hand 301 moves with the motion vector v(x, y, z) in the real space, the virtual hand 303 moves with a motion vector k·v(x, y, z) in the virtual space 302. FIG. 6A depicts k·v(x, y, z).

The output intensity of the ultrasonic wave by the haptic device 150 is Pw0, and the user hand 301 is separated from the haptic device 150 by a distance d in the direction of the normal vector n(x, y, z) of the ultrasonic wave output surface of the haptic device 150. In this case, an intensity Pw(d) of the haptic sensation that the user hand 301 receives is expressed by the following Expression 1. In Expression 1, D(d) is an attenuation coefficient of the ultrasonic wave corresponding to the distance d. FIG. 6B depicts Pw0, n(x, y, z), d, and Pw(d).

$$[ Math . 1 ]$$

$$P w ( d ) = Pw 0 \times D ( d ) \qquad ( Expression 1 )$$

The virtual object acquisition unit 111 acquires a maximum distance (maximum towing distance) h by which the virtual object 304 is movable in the virtual space 302. The maximum towing distance h is determined in advance. In FIG. 6C, h is depicted.

The virtual object acquisition unit 111 acquires a haptic sensation intensity Pw1 when the virtual hand 303 moves (lifts) the virtual object 304 by the maximum towing distance h. The haptic sensation intensity Pw1 may be interpreted as a virtual haptic sensation that the virtual hand 303 receives from the virtual object 304, or may be interpreted as an intensity of the haptic sensation that reproduces the virtual haptic sensation to be given to the user hand 301. The virtual object acquisition unit 111 calculates the haptic sensation intensity Pw1 on the basis of, for example, the type of the virtual object 304, the method for holding the virtual object 304 by the virtual hand 303, and the like. FIGS. 6C and 6D depict Pw1.

The haptic sensation limit distance acquisition unit 113 acquires (determines) a maximum distance H from the haptic device 150 in the direction of the normal vector n(x, y, z) at which the haptic device 150 can give the haptic sensation having the haptic sensation intensity Pw1 to the user hand 301 on the basis of the haptic sensation intensity Pw1. For example, the haptic sensation limit distance acquisition unit 113 acquires information (information indicating a correspondence relationship between the haptic sensation intensity and the distance from the haptic device 150) of the haptic sensation intensity Pw(d) in Expression 1 from the haptic device 150 via the communication unit 112. Then, the haptic sensation limit distance acquisition unit 113 acquires, as the maximum distance H, the distance d by which the haptic sensation intensity Pw(d)=Pw1. The information of the haptic sensation intensity Pw(d) is, for example, information of the haptic sensation intensity Pw(d) when the output intensity Pw0 of the ultrasonic wave is the maximum output intensity. FIG. 6D depicts H.

Note that, the haptic sensation limit distance acquisition unit 113 may calculate the maximum distance H on the basis of the haptic sensation intensity Pw1, the output intensity Pw0 of the ultrasonic wave, and attenuation information of the ultrasonic wave (information of an attenuation coefficient D(d); information of the correspondence relationship between the distance from the haptic device 150 and the attenuation coefficient of the ultrasonic wave). The output intensity Pw0 is, for example, the maximum output intensity. In this case, the haptic sensation limit distance acquisition unit 113 acquires information of the output intensity Pw0 of the ultrasonic wave from the haptic device 150 via the communication unit 112. The attenuation information is determined in advance, for example. When the haptic sensation intensity Pw1 is substituted into the haptic sensation intensity Pw(d) in Expression 1, an attenuation coefficient D1 corresponding to the haptic sensation intensity Pw1 can be calculated, and the distance d that satisfies the attenuation coefficient D(d)=D1 can be acquired as the maximum distance H.

The virtual movement ratio adjustment unit 114 calculates (determines) an linking coefficient r k after adjustment by an adjustment degree r on the basis of the maximum distance H and the maximum towing distance h. The adjustment degree r is a coefficient having the same dimension as the linking coefficient k, and in a case where the linking coefficient k is a one-dimensional coefficient, the adjustment degree r is also a one-dimensional coefficient. The linking coefficient r·k after adjustment is, for example, a ratio of the maximum towing distance h to the movement distance of the user hand 301 when the user hand 301 is separated from the haptic device 150 by the maximum distance H in order to move the virtual object 304, and is calculated from the following Expression 2. In Expression 2, H0 is a distance from the haptic device 150 to the user hand 301 in the direction of the normal vector n(x, y, z) at a point in time of S406. FIG. 6D depicts H0.

$$[ Math . 2 ]$$

$$r \cdot k = \frac{h}{H - H 0} \qquad ( Expression 2 )$$

The virtual movement ratio adjustment unit 114 converts the motion vector v(x, y, z) of the user hand 301 into a motion vector v′(x, y, z) of the virtual hand 303 according to the linking coefficient k before adjustment by using the following Expression 3.

$$[ Math . 3 ]$$

$${v}^{′} = k \cdot v ( x , y , z ) \qquad ( Expression 3 )$$

The virtual movement ratio adjustment unit 114 performs adjustment by the adjustment degree r only in the direction of the normal vector n(x, y, z) of the ultrasonic wave output surface. Thus, the virtual movement ratio adjustment unit 114 orthographically projects the motion vector v′(x, y, z) of the virtual hand 303 in a direction of the vector n′(x, y, z) in the virtual space corresponding to the normal vector n(x, y, z) of the ultrasonic wave output surface. As a result, it is possible to obtain components corresponding to the directions of the normal vector n(x, y, z) and the vector n′(x, y, z), which are included in the motion vector v′(x, y, z) of the virtual hand 303. The vector n′(x, y, z) in the virtual space is a vector obtained by multiplying the normal vector n(x, y, z) of the ultrasonic wave output surface by the linking coefficient k. A vector v″ obtained by orthogonally projecting the motion vector v′(x, y, z) of the virtual hand 303 in the direction of the vector n′(x, y, z) in the virtual space can be calculated by using the following Expression 4.

$$[ Math . 4 ]$$

$${v}^{″} = \frac{{n}^{′} \cdot {v}^{′}}{{\vert {n}^{′} \vert}^{2}} {n}^{′} \qquad ( Expression 4 )$$

Then, the virtual movement ratio adjustment unit 114 calculates a motion vector u by the following Expression 5 and moves the virtual hand 303 with the calculated motion vector u. In the following Expression 5, 1 is a unit vector.

$$[ Math . 5 ]$$

$$\begin{matrix}u & = r \cdot {v}^{″} + ( {v}^{′} - {v}^{″} ) = ( r - 1 ) \cdot {v}^{″} + {v}^{′} \\ & = k \cdot ( ( r - 1 ) \cdot \frac{n \cdot v}{{\vert n \vert}^{2}} \cdot n + v )\end{matrix} \qquad ( Expression 5 )$$

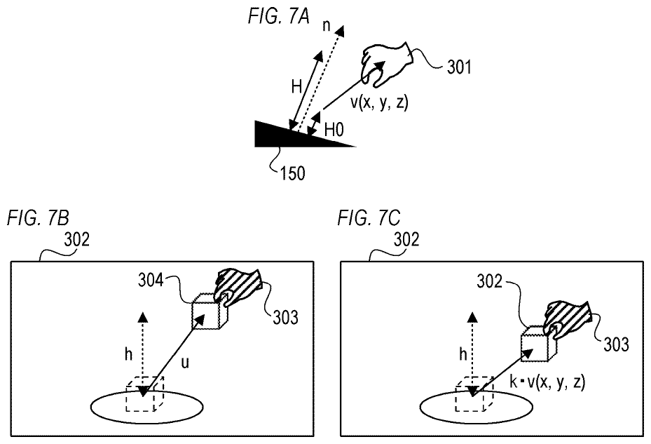

A difference between a case where the processing of S407 is performed and a case where the processing is not performed will be described with reference to FIGS. 7A to 7C. FIG. 7A illustrates the haptic device 150 as viewed from the side surface of the haptic device 150. FIGS. 7B and 7C illustrate videos in the virtual space 302 displayed by the display unit 115 and visually recognized by the user. In a case where the processing of S407 is performed, as illustrated in FIGS. 7A and 7B, when the user hand 301 is separated from the haptic device 150 with the motion vector v(x, y, z), the virtual hand 303 moves with the motion vector u. At this time, the user hand 301 is separated from the haptic device 150 by the distance H in the direction of the normal vector n(x, y, z) of the ultrasonic wave output surface, and the virtual object 304 is lifted by the distance h in the direction of the vector n′(x, y, z). Since the virtual object 304 is no longer lifted in the direction of the vector n′(x, y, z), the user hand 301 is not further separated from the haptic device 150. In a case where the processing of S407 is not performed, as illustrated in FIGS. 7A and 7C, when the user hand 301 is separated from the haptic device 150 with the motion vector v(x, y, z), the virtual hand 303 moves only with the motion vector k v(x, y, z). Thus, there is room for lifting the virtual object 304, and the user hand 301 is further separated from the haptic device 150.

In S408, the CPU 101 determines whether or not the virtual operation part is separated from the virtual object. For example, the CPU 101 determines whether or not the virtual hand 303 is separated from the virtual object 304. In a case where the virtual operation part is separated from the virtual object, the processing proceeds to S409, and otherwise, the processing proceeds to S410. The determination in S408 can be performed in the same manner as the determination in S404.

In S409, the CPU 101 causes the virtual movement ratio adjustment unit 114 to cancel the adjustment in S407. As a result, for example, the virtual movement ratio adjustment unit 114 moves the virtual hand 303 with the motion vector k·v(x, y, z) when the user hand 301 moves with the motion vector v(x, y, z). In addition, the virtual movement ratio adjustment unit 114 adjusts coordinates of the virtual hand 303 such that the virtual hand 303 is arranged at coordinates k·p(x, y, z) when the user hand 301 is present at the coordinates p(x, y, z). This adjustment may be performed instantaneously or stepwise.

In S410, the CPU 101 determines whether or not the HMD 100 receives a command to end the operation. The command to end the operation of the HMD 100 is, for example, a command corresponding to an operation to turn off the power of the HMD 100, a command corresponding to an operation to stop an application that provides the virtual space to the user, or the like. In a case where the HMD 100 receives the command to end the operation, the operation of FIG. 4 is ended, and otherwise, the processing proceeds to S401.

According to the above operation, the linking coefficient is increased from the predetermined ratio (k) at a first timing when the virtual operation part starts moving the virtual object. Then, the linking coefficient is returned to the predetermined ratio at a second timing when the touch of the virtual operation part with the virtual object is canceled. At the same time, the position of the virtual operation part is updated to the position of the virtual operation part in a case where the predetermined ratio is used as the linking coefficient from the first timing to the second timing. Note that, the first timing and the second timing are not limited thereto. For example, the first timing may be a timing when the virtual operation part comes into contact with the virtual object.

The operations of the haptic device 150 will be described. In S451, the CPU 151 determines whether or not the communication unit 156 receives the command in S402 or S403 from the HMD 100. In a case where the command is received, the processing proceeds to S452, and otherwise, the processing proceeds to S454.

In S452, the CPU 151 causes the ultrasonic control unit 157 to control (adjust) the ultrasonic waves output from the haptic sensation output unit 158. For example, in a case where the command of S402 is received, an ultrasonic wave having a phase, a frequency, and an amplitude corresponding to the command is determined as the ultrasonic waves to be output from the haptic sensation output unit 158. In a case where the command of S403 is received, it is determined not to output the ultrasonic waves from the haptic sensation output unit 158.

Various known methods can be used to adjust the ultrasonic waves. For example, a method for performing acoustic calculation on the basis of the haptic sensation intensity, the position and orientation of the user operation part, or the like can be used. The information of the haptic sensation intensity and the information of the position and orientation of the user operation part are included in the command of S402, for example.

In S453, the CPU 151 causes the haptic sensation output unit 158 to output the ultrasonic waves (or not to output the ultrasonic waves) in accordance with the processing result of S452.

In S454, the CPU 151 determines whether or not the haptic device 150 receives the command to end the operation. The command to end the operation of the haptic device 150 is, for example, a command corresponding to the operation to turn off the power of the haptic device 150. In a case where the haptic device 150 receives the command to end the operation, the operation of FIG. 4 is ended, and otherwise, the processing proceeds to S451.

As described above, according to the first embodiment, the position and orientation of the virtual operation part are determined such that the virtual operation part moves by the movement distance larger than the movement distance of the user operation part. As a result, even in a case where the user wants to greatly move the virtual operation part, it is possible to suppress the excessive separation of the user operation part from the haptic device 150, suppress the unnecessary change in the haptic sensation, and perform haptic sensation presentation without the sense of discomfort of the user.

In addition, the adjustment of the linking coefficient (the degree of movement of the virtual operation part) is performed only in a specific direction, and thus, it is possible to reduce the sense of discomfort when the user operates the virtual operation part. Then, when the adjustment of the linking coefficient is canceled, the virtual operation part is returned to the position in the case where the adjustment of the linking coefficient is not performed, a positional deviation due to the adjustment of the linking coefficient can be eliminated, and the sense of discomfort of the user after the adjustment of the linking coefficient is canceled can be reduced.

Note that, in S406, the CPU 101 may calculate the normal vector n(x, y, z) from a plurality of vectors parallel to the ultrasonic wave output surface. The CPU 101 may store in advance information of the plurality of vectors parallel to the ultrasonic wave output surface, or may detect the ultrasonic wave output surface from the image (the image in the real space) processed by the imaging processing unit 106 and acquire the information of the plurality of vectors parallel to the ultrasonic wave output surface. In a case where the ultrasonic wave output surface is curved, a plane similar to an actual ultrasonic wave output surface may be considered instead of the actual ultrasonic wave output surface (curved surface) such that the normal vector n(x, y, z) is uniquely determined.

In S406, in a case where the evaluation value N is too large, there is a high possibility that the movement of the user operation part is not an intentional movement. Thus, not only a lower limit threshold but also an upper limit threshold may be further used as the threshold of the evaluation value N. The CPU 101 may determine whether the evaluation value N is within a predetermined range (equal to or greater than the lower limit threshold and equal to or less than the upper limit threshold). Then, in a case where the evaluation value N is within the predetermined range, the CPU 101 may determine that the user operation part moves away from the haptic device 150 in the direction of the normal vector n(x, y, z). In a case where the evaluation value N is not within the predetermined range, the CPU 101 may determine that the user operation part does not move away from the haptic device 150 in the direction of the normal vector n(x, y, z).

In S407, the CPU 101 may acquire (determine) attenuation information (information of the attenuation coefficient D(d)) of the ultrasonic wave on the basis of the frequency of the ultrasonic wave output from the haptic device 150. For example, the CPU 101 may acquire frequency information of the ultrasonic wave from the haptic device 150 via the communication unit 112 and acquire attenuation information on the basis of the frequency information.

In S407, the CPU 101 may acquire (determine) the attenuation information (information of the attenuation coefficient D(d)) of the ultrasonic wave output from the haptic device 150 on the basis of the temperature in the real space. A temperature sensor that detects a temperature of the user operation part or the periphery (vicinity) of the haptic device 150 may be provided in the HMD 100 or the haptic device 150. In a case where the temperature sensor is provided in the haptic information, the CPU 101 may acquire temperature information in the real space from the haptic device 150 via the communication unit 112 and acquire the attenuation information on the basis of the temperature information. The CPU 101 may acquire the attenuation information on the basis of a plurality of pieces of information including temperature information, frequency information, or both the pieces of information.

In S407, the adjustment degree r may not depend on the distance d from the haptic device 150 to the user hand 301, or may be an adjustment degree r (d) that changes in accordance with the distance d. In the case of the adjustment degree r (d), the linking coefficient after the adjustment also changes in accordance with the distance d. In this case, the CPU 101 may cause the virtual object acquisition unit 111 to acquire, as the haptic sensation intensity Pw1, a haptic sensation intensity Pw1(d) that changes in accordance with the distance d.

In S407, the linking coefficient k may be a coefficient matrix of 3 rows×3 columns, and in an initial state, the degree of movement of the virtual operation part (the ratio of the movement distance of the virtual operation part to the movement distance of the user operation part) may be different depending on the direction.

In S407, not the three-dimensional coordinates (three-dimensional motion vector) but the two-dimensional coordinates (two-dimensional motion vector) may be converted or acquired by the calculation using the linking coefficient. For example, in a case where the linking coefficient is k, three-dimensional coordinates w(x, y, z) in the real space may be converted into two-dimensional coordinates k·w(x, y) in the two-dimensional video in the virtual space by the calculation using the linking coefficient k. The two-dimensional coordinates w(x, y) in the real space in a plane perpendicular to a direction in which the face of the user is directed may be converted into the two-dimensional coordinates k·w(x, y) in the two-dimensional video in the virtual space. In this case, the linking coefficient k may be a coefficient matrix of 2 rows×2 columns, and the degree of movement of the virtual operation part may be different depending on the direction.

The linking coefficient after adjustment initially determined in S407 may be continuously used until the adjustment of the linking coefficient is canceled in S409. The processing of S407 may be repeated until the adjustment of the linking coefficient is canceled in S409, and the linking coefficient after adjustment may be updated when there is a change in a parameter such as the output intensity of the ultrasonic wave and the intensity of the haptic sensation.

Although the linking coefficient (degree of movement of the virtual operation part) is adjusted on the basis of the maximum distance H and the maximum towing distance h, the linking coefficient may be adjusted on the basis of the maximum distance H instead of the maximum towing distance h. For example, another value greater than H-H0 may be used instead of the maximum towing distance h. The adjustment of the linking coefficient may be performed without being limited to the specific direction. The adjusted linking coefficient may be constantly used without performing the adjustment of the linking coefficient, and the position and orientation of the virtual operation part may be determined on the basis of only the position and orientation (and the linking coefficient) of the user operation part.

At least a part of the plurality of processing described as being performed by the HMD 100 may be performed by the external device (for example, the haptic device 150). At least a part of the plurality of processing described as being performed by the haptic device 150 may be performed by the external device (for example, the HMD 100). In these cases, the HMD 100 or the haptic device 150 may output (transmit) information necessary for processing by the external device to the external device. The HMD 100 and the haptic device 150 may acquire (receive) a processing result of the external device from the external device.

### Second Embodiment

A second embodiment of the present disclosure will be described. Note that, hereinafter, description of configurations and processing similar to those of the first embodiment will be omitted, and configurations and processing different from those of the first embodiment will be described.

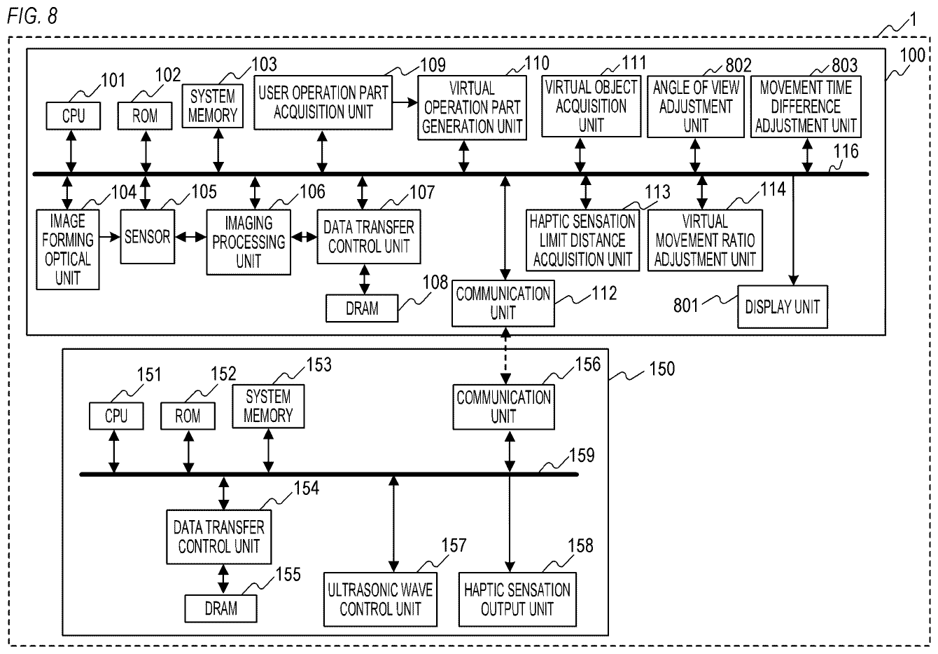

FIG. 8 is a block diagram illustrating a functional configuration of an information processing system 1 according to the second embodiment. A display unit 801 has the function of the display unit 115 of the first embodiment (FIG. 1) and the function of acquiring information regarding a viewing angle of the user (viewing angle information). An angle of view adjustment unit 802 adjusts an angle of view displayed on the display unit 801. In the second embodiment, the angle of view adjustment unit 802 is a zoom changing unit that changes a zoom magnification of the video in the virtual space to be presented to the user. A movement time difference adjustment unit 803 adjusts a delay time of the movement of the virtual operation part with respect to the movement of the user operation part.

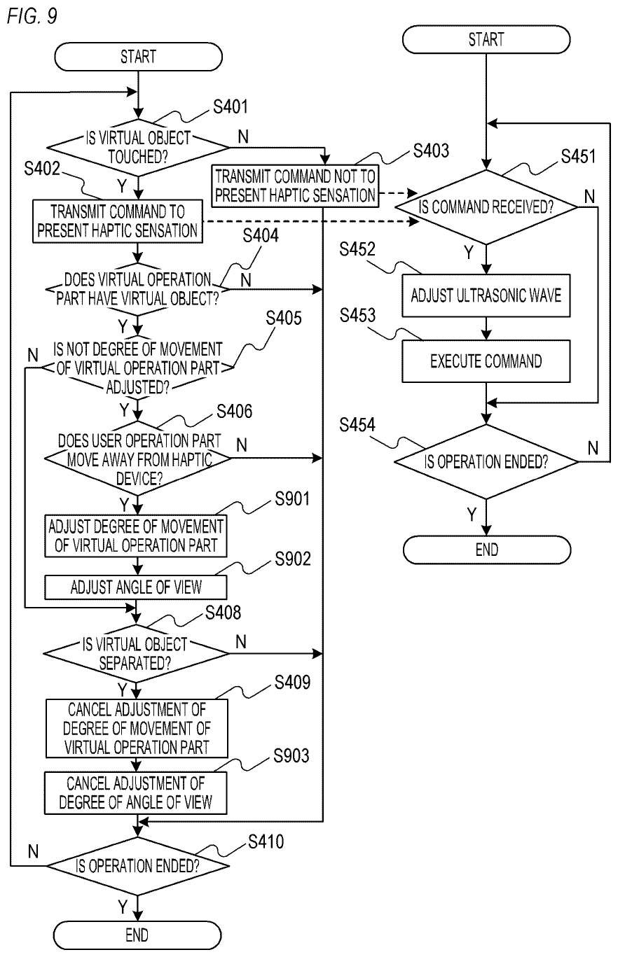

FIG. 9 is a flowchart illustrating an example of operations of an information processing system 1 according to the second embodiment. Operations (S401 to S410 and S901 to S905) of the HMD 100 are realized by the CPU 101 of the HMD 100 loading the program stored in the ROM 102 into the system memory 103 and executing the program. Operations (S451 to S454) of the haptic device 150 are realized by the CPU 151 of the haptic device 150 loading the program stored in the ROM 152 into the system memory 153 and executing the program. In FIG. 9, the same processing (steps) as those in the first embodiment (FIG. 4) are denoted by the same reference numerals as those in the first embodiment (FIG. 4).

Similarly to S407 in FIG. 4, in S901, the CPU 101 causes the virtual movement ratio adjustment unit 114 to adjust the degree of movement of the virtual operation part, and moves the virtual operation part. A method for acquiring the maximum towing distance h is different between S901 and S407.

In S901, the CPU 101 causes the display unit 801 to acquire the viewing angle information of the user. Various known methods can be used to acquire the viewing angle information. For example, a method for acquiring information in a predetermined range with a center of the video displayed by the display unit 801 as a center can be used. Since the video in the virtual space is displayed on the display unit 801, the viewing angle of the user may be interpreted as a perception range that is a range perceived by the user in the virtual space. The CPU 101 acquires (determines) the maximum towing distance h on the basis of the viewing angle information (and the vector n′ corresponding to the normal vector n). For example, the CPU 101 determines the maximum towing distance h such that the virtual object falls within the viewing angle (perception range) when the virtual object is lifted by the maximum towing distance h.

In S902, the CPU 101 causes the angle of view adjustment unit 802 to adjust the angle of view displayed on the display unit 801 on the basis of the distance d from the haptic device 150 to the user hand 301 in the direction of the normal vector n. In the second embodiment, the angle of view adjustment unit 802 changes the zoom magnification of the video in the virtual space to be presented to the user from a predetermined magnification (default value) such that the perception range is narrowed in accordance with an increase in the distance d and the perception range is widened in accordance with a decrease in the distance d. For example, the angle of view adjustment unit 802 adjusts the zoom magnification in accordance with a ratio of the distance d to the maximum distance H. The angle of view adjustment unit 802 increases the zoom magnification such that the perception range is narrowed by zooming-in when the distance d (≤H) approaches the maximum distance H, and decreases the zoom magnification such that the perception range is widened by zooming-out when the distance d moves away from the maximum distance H. However, the zooming-out is limited such that the perception range is not wider than the initial state.

By the processing of S902, the user can obtain a feeling as if the virtual object is moved by a larger movement amount, and eventually, the user operation part can be suppressed from being greatly separated from the haptic device 150. The angle of view adjustment unit 802 may adjust the zoom magnification such that the virtual operation part is positioned outside the perception range when the distance d coincides with the maximum distance H.

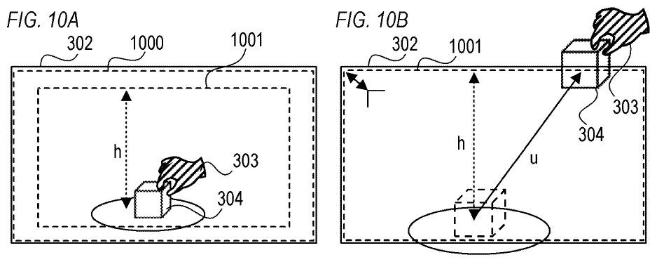

A part of the processing of S901 and S902 will be described with reference to FIGS. 10A and 10B. FIGS. 10A and 10B illustrate videos in the virtual space 302 displayed by the display unit 801 and visually recognized by the user. In FIG. 10A, the maximum towing distance h is determined such that, when the virtual object 304 is lifted by the maximum towing distance h, the virtual object 304 falls within a perception range 1000 before adjustment (default). In FIG. 10B, when the virtual hand 303 moves by the motion vector u, adjustment from the perception range 1000 in FIG. 10A to a perception range 1001 narrower than the perception range 1000 is performed by zooming-in. As a result, the virtual hand 303 having moved by the motion vector u is positioned outside the perception range 1001 and is invisible to the user. At this time, the virtual object 304 may or may not be visible to the user.

In S903, the CPU 101 causes the angle of view adjustment unit 802 to cancel the adjustment in S902.

According to the above operation, the zoom magnification of the video in the virtual space is increased from the predetermined magnification at the first timing when the virtual operation part starts moving the virtual object. Then, the zoom magnification is returned to the predetermined magnification at the second timing when the touch of the virtual operation part with the virtual object is canceled. The zoom magnification may be changed instantaneously or stepwise. In addition, as described in the first embodiment, the first timing and the second timing are not limited thereto.

As described above, according to the second embodiment, even though the maximum towing distance h cannot be acquired from the outside, effects similar to those of the first embodiment can be obtained by determining the maximum towing distance h on the basis of the information of the viewing angle (viewing range) of the user. In addition, the zoom magnification of the video in the virtual space is adjusted on the basis of the distance from the haptic device 150 to the user hand 301. As a result, the user can obtain a feeling as if the virtual object is moved by a larger movement amount, and eventually, it is possible to suppress the user operation part from being greatly separated from the haptic device 150. Then, when the adjustment of the linking coefficient is canceled, the adjustment of the zoom magnification is also canceled, and thus, it is possible to reduce the sense of discomfort of the user after the adjustment of the linking coefficient is canceled.

Note that, in S901, the CPU 101 may cause the movement time difference adjustment unit 803 to increase the delay time of the movement of the virtual operation part with respect to the movement of the user operation part from a predetermined delay time (default value). As a result, the user can have the illusion that the virtual object 304 is heavy. In this case, in S409, the CPU 101 may cause the movement time difference adjustment unit 803 to return the delay time to the predetermined delay time.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, the haptic sensation presentation without the sense of discomfort of the user can be performed in aerial haptics.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-203202, filed Nov. 21, 2024, which is hereby incorporated by reference herein in its entirety.

What is claimed is:

1. An information processing apparatus comprising:
a processor; and
a memory storing a program which, when executed by the processor, causes the information processing apparatus to
execute acquisition processing of acquiring information of a position and an orientation of an operation part that is a part of a user performing an operation, and
execute determination processing of determining a position and an orientation of a virtual operation part corresponding to the operation part, in a virtual space to be presented to the user, on a basis of the position and orientation of the operation part,
wherein a haptic sensation reproducing a virtual haptic sensation that the virtual operation part receives from a virtual object in the virtual space is applied to the operation part by an ultrasonic wave from a haptic device, and
in the determination processing, the position and orientation of the virtual operation part are determined such that the virtual operation part moves by a movement distance larger than a movement distance of the operation part.

2. The information processing apparatus according to claim 1,
wherein, in the determination processing, a ratio of the movement distance of the virtual operation part to the movement distance of the operation part is determined on a basis of a maximum distance from the haptic device that is able to apply the haptic sensation reproducing the virtual haptic sensation to the operation part.

3. The information processing apparatus according to claim 2,
wherein, in the determination processing, the ratio that changes in accordance with a distance from the haptic device to the operation part is determined.

4. The information processing apparatus according to claim 2,
wherein, in the determination processing, the ratio is determined on a basis of a first maximum distance by which the virtual object is movable in the virtual space and a second maximum distance that is the maximum distance from the haptic device, the second maximum distance being able to apply the haptic sensation reproducing the virtual haptic sensation when the virtual operation part moves the virtual object by the first maximum distance to the operation part.

5. The information processing apparatus according to claim 4,
wherein, in the determination processing, a ratio of the first maximum distance to the movement distance of the operation part when the operation part moves away from the haptic device by the second maximum distance in order to move the virtual object is determined as the ratio.

6. The information processing apparatus according to claim 4,
wherein, in the determination processing, the second maximum distance is determined on a basis of an intensity of the virtual haptic sensation or the haptic sensation when the virtual operation part moves the virtual object by the first maximum distance.

7. The information processing apparatus according to claim 6,
wherein, in the determination processing, the second maximum distance is determined on a basis of the intensity of the virtual haptic sensation or the haptic sensation when the virtual operation part moves the virtual object by the first maximum distance, and a correspondence relationship between an intensity of the haptic sensation given from the haptic device to the operation part and a distance from the haptic device to the operation part.

8. The information processing apparatus according to claim 6,
wherein, in the determination processing, the second maximum distance is determined on a basis of the intensity of the virtual haptic sensation or the haptic sensation when the virtual operation part moves the virtual object by the first maximum distance, an output intensity of the ultrasonic wave by the haptic device, and attenuation information of the ultrasonic wave.

9. The information processing apparatus according to claim 8,
wherein, the output intensity of the ultrasonic wave by the haptic device is a maximum output intensity.

10. The information processing apparatus according to claim 8,
wherein, in the determination processing, the attenuation information is determined on a basis of a frequency of the ultrasonic wave.

11. The information processing apparatus according to claim 8,
wherein, in the determination processing, the attenuation information is determined on a basis of a temperature in a real space.

12. The information processing apparatus according to claim 6,
wherein, in the determination processing, an intensity that changes in accordance with a distance from the haptic device to the operation part is used as the intensity of the virtual haptic sensation or the haptic sensation when the virtual operation part moves the virtual object by the first maximum distance.

13. The information processing apparatus according to claim 4,
wherein, in the determination processing, the first maximum distance is determined on a basis of a perception range that is a range perceived by the user in the virtual space.

14. The information processing apparatus according to claim 13,
wherein, the program, when executed by the processor, further causes the information processing apparatus to execute zoom change processing of changing a zoom magnification of a video in the virtual space to be presented to the user such that the perception range narrows in accordance with an increase in a distance from the haptic device to the operation part and the perception range widens in accordance with a decrease in the distance from the haptic device to the operation part.

15. The information processing apparatus according to claim 14,
wherein, in the determination processing, the ratio of the movement distance of the virtual operation part to the movement distance of the operation part is increased from a predetermined ratio at a first timing, and the ratio is returned to the predetermined ratio at a second timing after the first timing, and
in the zoom change processing, the zoom magnification is increased from a predetermined magnification at the first timing, and the zoom magnification is returned to the predetermined magnification at the second timing.

16. The information processing apparatus according to claim 1,
wherein, in the determination processing, a ratio of the movement distance of the virtual operation part to the movement distance of the operation part is increased from a predetermined ratio at a first timing, and the ratio is returned to the predetermined ratio at a second timing after the first timing, and
the program, when executed by the processor, further causes the information processing apparatus to execute delay change processing of increasing a delay of movement of the virtual operation part with respect to movement of the operation part from a predetermined delay at the first timing and returning the delay to the predetermined delay at the second timing.

17. The information processing apparatus according to claim 1,
wherein, in the determination processing,
a ratio of the movement distance of the virtual operation part to the movement distance of the operation part is increased from a predetermined ratio at a first timing, and
the ratio is returned to the predetermined ratio at a second timing after the first timing, and the position of the virtual operation part is updated to a position of the virtual operation part in a case where the predetermined ratio is used as the ratio from the first timing to the second timing.

18. The information processing apparatus according to claim 15,
wherein the first timing is a timing at which the virtual operation part starts moving the virtual object.

19. The information processing apparatus according to claim 15,
wherein the second timing is a timing when touch of the virtual operation part with the virtual object is canceled.

20. The information processing apparatus according to claim 1,
wherein, in the determination processing,
a ratio of the movement distance of the virtual operation part to the movement distance of the operation part is not changed in a direction not perpendicular to an output surface of the ultrasonic wave in the haptic device, and
the ratio of the movement distance of the virtual operation part to the movement distance of the operation part is changed in a direction perpendicular to the output surface of the ultrasonic wave in the haptic device.

21. An information processing method comprising:
acquiring information of a position and an orientation of an operation part that is a part of a user performing an operation; and
determining a position and an orientation of a virtual operation part corresponding to the operation part, in a virtual space to be presented to the user, on a basis of the position and orientation of the operation part,
wherein a haptic sensation reproducing a virtual haptic sensation that the virtual operation part receives from a virtual object in the virtual space is applied to the operation part by an ultrasonic wave from a haptic device, and
the position and orientation of the virtual operation part are determined such that the virtual operation part moves by a movement distance larger than a movement distance of the operation part.

22. A non-transitory computer readable medium that stores a program, wherein the program causes a computer to execute an information processing method comprising:
acquiring information of a position and an orientation of an operation part that is a part of a user performing an operation; and
determining a position and an orientation of a virtual operation part corresponding to the operation part, in a virtual space to be presented to the user, on a basis of the position and orientation of the operation part,
wherein a haptic sensation reproducing a virtual haptic sensation that the virtual operation part receives from a virtual object in the virtual space is applied to the operation part by an ultrasonic wave from a haptic device, and
the position and orientation of the virtual operation part are determined such that the virtual operation part moves by a movement distance larger than a movement distance of the operation part.
